(19) United States
(12) Patent Application Publication
(10) Pub. No.: US 2018/0039407 A1
(43) Pub. Date: Feb. 8, 2018

(54) DISPLAY DEVICE AND DISPLAY CONTROL METHOD

(71) Applicant: SEIKO EPSON CORPORATION, Tokyo (JP)

(72) Inventor: Issei YOKOYAMA, Sapporo-shi (JP)

(73) Assignee: SEIKO EPSON CORPORATION, Tokyo (JP)

(21) Appl. No.: 15/555,032

(22) PCT Filed: Feb. 16, 2016
(86) PCT No.: PCT/JP2016/000785

§ 371 Date: Aug. 31, 2017

(30) Foreign Application Priority Data
Mar. 4, 2015 (JP) 2015-042684

(51) Int. Cl. G06F 3/0488; G09G 5/14; G06F 3/03; G06F 3/14; G06F 3/0487; G06F 3/042

(52) U.S. Cl. CPC G06F 3/04886; G06F 3/0487; G06F 3/0425; G06F 3/0308; G06F 3/14; G09G 5/14

(57) ABSTRACT

A display device includes an image acquisition section adapted to obtain a plurality of image signals, a display section adapted to display images represented by the image signals obtained by the image acquisition section, a position detection section adapted to detect a position pointed by a pointer on a screen displayed by the display section, a drawing section adapted to perform drawing in the screen in accordance with the position detected by the position detection section, an operation detection section adapted to detect an operation performed by the pointer on the screen, and a screen split section adapted to split the screen displayed by the display section into a plurality of areas in accordance with the position detected by the position detection section, and allocate the images represented by the image signals obtained by the image acquisition section to the respective areas.

### TECHNICAL FIELD

The present invention relates to a technology of splitting a screen into a plurality of areas to display an image in each of the areas.

### BACKGROUND ART

In PTL 1, there is disclosed a technology of changing a projection ratio between a main image and a sub-image in a projection device for projecting the main image and the sub-image. This projection device projects a pointer, moves the position of the pointer in accordance with an operation of a cursor key, makes the size of a rectangular frame corresponding to the main image variable, and makes the size of a rectangle corresponding to the sub-image variable in an opposite direction to the variable direction of the main image to thereby change the projection ratio between the main image and the sub-image.

### CITATION LIST

### Patent Literature

PTL 1: JP-A-2009-133985

### SUMMARY OF INVENTION

### Technical Problem

In the case of using the projector in, for example, a presentation, the user performs the presentation around the projected image. In the case of performing the presentation with, for example, a plurality of image sources projected in this state, it is necessary for the user to move to the place where the projector is installed to operate the projector, or to operate a remote controller, to thereby project the main image and the sub-image, and then change the projection ratio between the images thus projected. However, in the case of moving to the installation place of the projector to operate the projector main body, if the distance between the projector and the projection surface of the images is long, it takes time to move to the installation place of the projector. Further, although it is possible to change the projection ratio with the operation of a key of the remote controller, it is necessary to take along the remote controller or to keep the remote controller around, which requires great care.

The invention provides a technology of splitting an image displayed into a plurality of areas with a simple operation.

### Solution to Problem

The invention provides a display device including an image acquisition section adapted to obtain a plurality of image signals, a display section adapted to display images represented by the image signals obtained by the image acquisition section, a position detection section adapted to detect a position pointed by a pointer on a screen displayed by the display section, a drawing section adapted to perform drawing in the screen in accordance with the position detected by the position detection section, an operation detection section adapted to detect an operation performed by the pointer on the screen, and a screen split section adapted to split the screen displayed by the display section into a plurality of areas in accordance with the position detected by the position detection section in a case in which a first operation is detected by the operation detection section, and allocate the images represented by the image signals obtained by the image acquisition section to the respective areas so that the images different from each other are displayed in the plurality of areas.

According to this display device, the screen can easily be split into a plurality of areas by an operation with the pointer.

The invention may adopt a configuration in which in a case in which the operation detection section detects a second operation in a state in which the screen is split, and then the position detected by the position detection section changes, the screen split section changes sizes of the plurality of areas in accordance with the position having been changed.

According to this configuration, the sizes of the split areas can be changed by a specific operation.

Further, the invention may adopt a configuration in which at least one of the first operation and the second operation is an operation of making the pointer have contact with the screen a plurality of times.

According to this configuration, the screen can be split into a plurality of areas by a simple operation.

Further, the invention may adopt a configuration in which the screen split section determines the number of the plurality of areas in accordance with the position detected by the position detection section.

According to this configuration, the number of the plurality of areas can be changed in accordance with the position of the pointer.

Further, the invention may adopt a configuration in which the screen split section determines the number of the plurality of areas in accordance with the number of the image signals obtained by the image acquisition section.

According to this configuration, the number of the plurality of areas can be changed in accordance with the presence or absence of the image signals.

Further, the invention may adopt a configuration in which in a case in which the operation detection section detects a third operation in a state in which the screen is split, the screen split section exchanges the image displayed in a first position pointed by the pointer and the image displayed in a second position pointed by the pointer for each other.

According to this configuration, the positions of the images displayed in the plurality of areas can be exchanged for each other.

Further, the invention may adopt a configuration in which the drawing section skips drawing in accordance with the position of the pointer with respect to an operation detected by the operation detection section.

According to this configuration, it is possible to prevent drawing from being performed in accordance with the operation of splitting the screen into a plurality of areas.

In addition, the invention provides a display control method including a position detection step of detecting a position pointed by a pointer on a screen displayed by a display section, a drawing step of performing drawing in the screen in accordance with the position detected in the position detection step, an operation detection step of detecting an operation performed by the pointer on the screen, and a screen split step of splitting the screen displayed by the display section into a plurality of areas in accordance with the position detected in the position detection step in a case in which a first operation is detected in the operation detection step, and allocating images represented by image signals obtained by an image acquisition section to the respective areas so that the images different from each other are displayed in the plurality of areas.

According to this method, the screen can easily be split into a plurality of areas by an operation with the pointer.

### BRIEF DESCRIPTION OF DRAWINGS

FIG. 1 is a diagram showing a device constituting a display system 1.

FIG. 2 is a diagram showing a hardware configuration of a projector 10 and a pointer 20.

FIG. 3 is a diagram showing information stored in a first table.

FIG. 4 is a functional block diagram of a control section 110 and a control section 210.

FIG. 5 is a diagram showing an example of a time chart of detecting the pointer.

FIG. 6 is a flowchart showing a flow of a process executed by the control section 110.

FIG. 7 is a diagram showing coordinates of a projection area.

FIG. 8 is a diagram showing a relationship between a split position Pos and the projection area thus split.

FIG. 9 is a flowchart showing a flow of a process executed by the control section 110.

FIG. 10 is a diagram showing a relationship between the split position Pos and the projection area thus split.

### DESCRIPTION OF EMBODIMENTS

### Embodiment

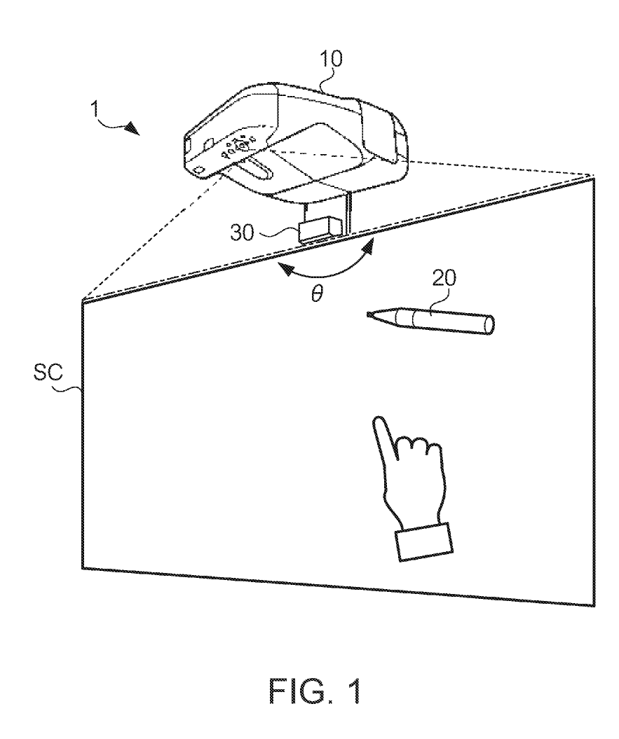

FIG. 1 is a diagram showing a device constituting a display system 1 according to an embodiment of the invention. The display system 1 is provided with a projector 10 for projecting an image on a screen SC (a projection surface), a pointer 20, and a light emitting device 30.

The projector 10 as an example of the display device is connected to an external device for supplying an image signal, and projects an image represented by the image signal, which is supplied from the external device, on the screen SC. Further, the projector 10 is provided with an interactive function of performing writing to the image projected with a finger or the pointer 20. The projector 10 according to the present embodiment is disposed obliquely above the screen SC, and projects the image toward the screen SC. Although in the present embodiment, the projector 10 projects the image toward the screen SC, it is also possible to project the image on a wall surface (the projection surface) instead of the screen SC. Further, in the present embodiment, the projector 10 has a configuration of being mounted on the wall surface with a bracket, but can also be mounted on the ceiling. Further, the projector 10 is not limited to the configuration of being mounted on the wall surface or the ceiling, but can also be a standing type to be disposed on a table.

The pointer 20 having a pen-like shape functions as a pointing device for operating the projector 10, and is used when the user operates the GUI (Graphical User Interface) projected by the projector 10, when the user performs writing to the image thus projected, and so on.

The light emitting device 30 has a light emitting section for emitting light (infrared light in the present modified example). The light emitting device 30 is disposed above an upper end of the screen SC, and emits the light dispersed in a range of the angle θ downward. The light emitted from the light emitting device 30 forms a layer of light extending along the screen SC. In the present embodiment, the angle θ reaches about 180 degrees, and thus, the layer of light is formed on the roughly entire area of the screen SC. It is preferable for the surface of the screen SC and the layer of light formed by the light emitting device 30 to be adjacent to each other. The projector 10 controls emission of the light from the light emitting device 30.

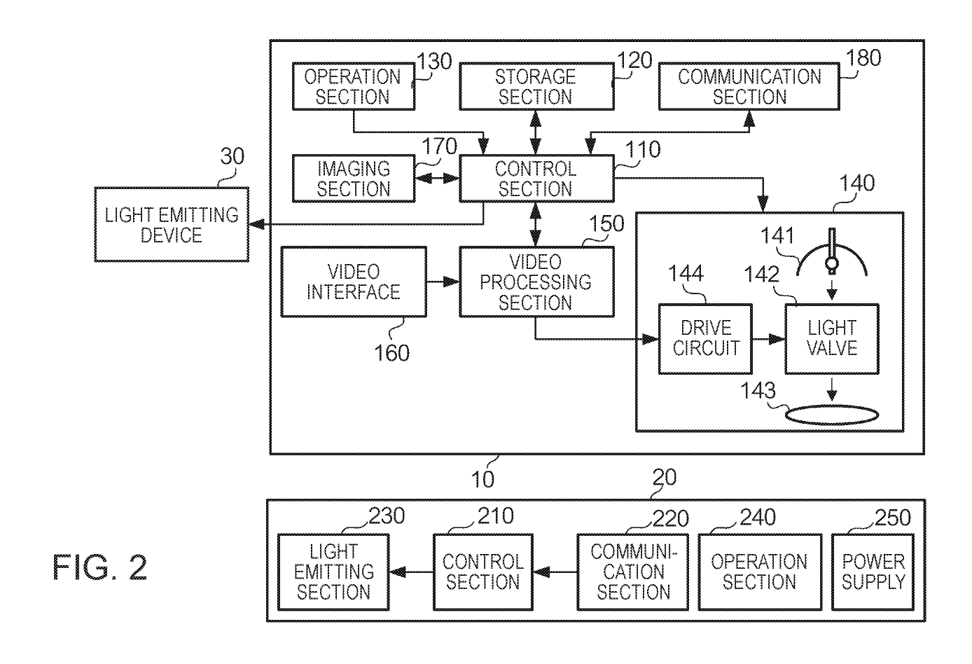

FIG. 2 is a diagram showing a hardware configuration of the projector 10 and the pointer 20. The pointer 20 has a control section 210, a communication section 220, a light emitting section 230, an operation section 240, and a power supply 250. The power supply 250 is, for example, a dry battery or a secondary cell, and supplies the control section 210, the communication section 220, the light emitting section 230, and the operation section 240 with electric power. The operation section 240 is provided with a switch (not shown) for controlling the supply of the electric power from the power supply 250 to each of the sections. When the switch of the operation section 240 is set to the ON state, the electric power is supplied from the power supply 250 to each of the sections, and when the switch of the operation section 240 is set to the OFF state, the supply of the electric power from the power supply 250 to each of the sections is stopped. The light emitting section 230 has a light emitting diode for emitting infrared light, and is disposed on the tip of the pointer 20. The control section 210 controls lighting and extinction of the light emitting section 230. The light emitting section 230 is a point light source, and the light emitted by the light emitting section 230 spreads from the tip of the pointer 20 in a spherical manner. The communication section 220 is provided with a light receiving element for receiving the infrared light. The communication section 220 receives a variety of signals transmitted from the projector 10 with the infrared light. The communication section 220 converts the variety of signals thus received into electric signals, and then supplies the control section 210 with the electric signals. The control section 210 is connected to the light emitting section 230 and the communication section 220. The control section 210 starts the control of the light emitting section 230 in accordance with the signal supplied from the communication section 220 to control lighting and extinction of the light emitting diode of the light emitting section 230. The control section 210 and the light emitting section 230 function as a light emitting device for making the pointer 20 emit light.

The projector 10 is provided with a control section 110, a storage section 120, an operation section 130, and a projection section 140. Further, the projector 10 is provided with an image processing section 150, an image interface 160, an imaging section 170, and a communication section 180. The control section 110 is a microcomputer provided with a CPU (Central Processing Unit), a ROM (Read Only Memory), and a RAM (Random Access Memory). When the CPU executes a program stored in the ROM, the control section 110 controls each of the sections to realize a function of projecting an image on the screen SC, an interactive function, a function of using a finger and the pointer 20 as a pointing device, and so on in the projector 10.

Further, in the projector 10, there are realized a variety of functions such as a function of controlling emission of the infrared light from the light emitting device 30 connected to the control section 110, a screen split function of splitting a rectangular projection area for displaying the image into a plurality of areas and projecting the image of the imagesignal supplied from an external device on the areas obtained by the split, a function of changing the number or the areas of the areas obtained by the split, and a function of exchanging the images to be projected on the areas obtained by the split.

The image interface 160 has a plurality of connectors supplied with an image signal such as RCA, D-sub, HDMI (registered trademark), or USB, and supplies the image processing section 150 with the image signal supplied from the external device to the connectors. The image interface 160 is an example of an image acquisition section for obtaining a plurality of image signals. It is also possible for the image interface 160 to have an interface for wireless communication such as wireless LAN or Bluetooth (registered trademark) to obtain the image signals with the wireless communication.

The storage section 120 stores a setting value related to the image quality of the image to be projected and information related to the setting of a variety of functions. Further, the storage section 120 stores a first table storing a correspondence relationship between the areas of the projection area split by the screen split function and the image signals of the images to be projected on the respective areas.

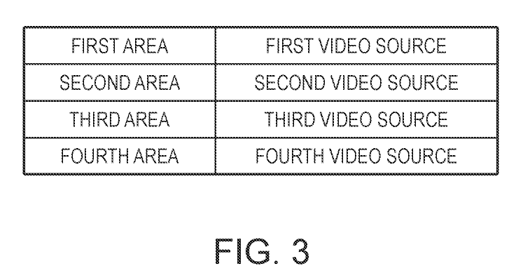

In the present embodiment, in the case in which the screen split function has been performed, the projection area is split into up to four areas, namely first through fourth areas. Therefore, in the first table in the initial state, regarding the first through fourth areas, a first image source S1 is associated with the first area, a second image source S2 is associated with the second area, a third image source S3 is associated with the third area, and a fourth image source S4 is associated with the fourth area, as shown in FIG. 3.

The operation section 130 is provided with a plurality of buttons for operating the projector 10. By the control section 110 controlling each of the sections in accordance with the button having been operated, an adjustment of the image to be projected on the screen SC, setting of a variety of functions provided to the projector 10, and so on are performed. Further, the operation section 130 is provided with a light receiving section (not shown) for receiving an infrared signal from a remote controller (not shown). The operation section 130 converts the signal transmitted from the remote controller into an electric signal to supply the control section 110, and then the control section 110 controls each of the sections in accordance with the signal supplied.

The projection section 140 and the image processing section 150 function as a display section for displaying an image in cooperation with each other.

The image processing section 150 obtains the image signal supplied from the image interface 160. Further, the image processing section 150 obtains the signal of an on-screen image such as a GUI for operating the projector 10, a cursor showing a position pointed by the pointer 20, and an image drawn with the interactive function from the control section 110. The image processing section 150 is provided with a variety of image processing functions, and performs image processing on the image signal supplied from the image interface 160 to adjust the image quality of the image to be projected. In the case in which the image processing section 150 is supplied with the signal of the on-screen image from the control section 110, the image processing section 150 supplies the projection section 140 with the image signal on which the signal of the on-screen image is superimposed.

Further, in the case in which the control section 110 performs the screen split function, the image processing section 150 splits the projection area into a plurality of areas, then generates an image signal in which the image of the image signal supplied from the external device is allocated to the areas obtained by the split, and then supplies the projection section 140 with the image signal thus generated.

The projection section 140 for projecting the image includes a light source 141, a light valve 142, a drive circuit 144, and a projection optical system 143. The light source 141 is a lamp for emitting light, and the light emitted by the light source 141 is dispersed by a plurality of dichroic mirrors and mirrors not shown into light beams of red, green, and blue, and the light beams of red, green, and blue obtained by the dispersion are guided to the light valve 142. It should be noted that the light source 141 can also be a light emitting diode or a semiconductor laser device for emitting a laser beam instead of the lamp.

The drive circuit 144 obtains the image signal supplied from the image processing section 150. The image signal supplied to the drive circuit 144 includes grayscale data representing a grayscale of a red component in the image to be projected, grayscale data representing a grayscale of a green component in the image to be projected, and grayscale data representing a grayscale of a blue component in the image to be projected. The drive circuit 144 extracts the grayscale data of each of the colors of red, green, and blue to drive the light valve 142 based on the grayscale data of each color thus extracted.

The light valve 142 includes a liquid crystal light valve to which the red light beam described above is input, a liquid crystal light valve to which the green light beam described above is input, and a liquid crystal light valve to which the blue light beam described above is input. The liquid crystal light valves are each a transmissive liquid crystal panel, and are each provided with pixels arranged in a matrix with a plurality of rows and a plurality of columns. The liquid crystal light valve to which the red light beam is input is driven based on the red grayscale data, the liquid crystal light valve to which the green light beam is input is driven based on the green grayscale data, and the liquid crystal light valve to which the blue light beam is input is driven based on the blue grayscale data. In each of the liquid crystal light valves, the drive circuit 144 controls each of the pixels to vary the transmittance of the pixel. By controlling the transmittance of the pixels, the light beams of the respective colors having been transmitted through the respective liquid crystal light valves form the images corresponding to the respective grayscale data. The images of the light beams of red, green, and blue having been transmitted through the respective liquid crystal light valves are combined with each other by a dichroic prism not shown, and then enter the projection optical system 143. The projection optical system 143 is an optical system for enlarging the image having entered the projection optical system 143, and projects the image having entered the projection optical system 143 on the screen SC in an enlarged manner using a lens or a mirror.

The imaging section 170 is provided with an imaging element (e.g., CMOS or CCD) for receiving the infrared light emitted by the light emitting section 230 and the infrared light, which has been emitted from the light emitting device 30 and then reflected by a finger, an optical system for forming an image on the imaging element, an aperture for limiting the light entering the imaging element, and so on. The imaging section 170 has an imaging range including the screen SC, generates an image of the range thus imaged, and then outputs an image signal representing the image thus generated. It should be noted that in the present embodiment, since the projector 10 is installed obliquely above the screen SC, it results that the imaging section 170 images the range including the screen SC from obliquely above. The communication section 180 is provided with a light emitting diode for emitting infrared light. The communication section 180 is controlled by the control section 110 in lighting and extinction of the light emitting diode, and transmits an infrared signal for controlling lighting and extinction of the light emitting section 230.

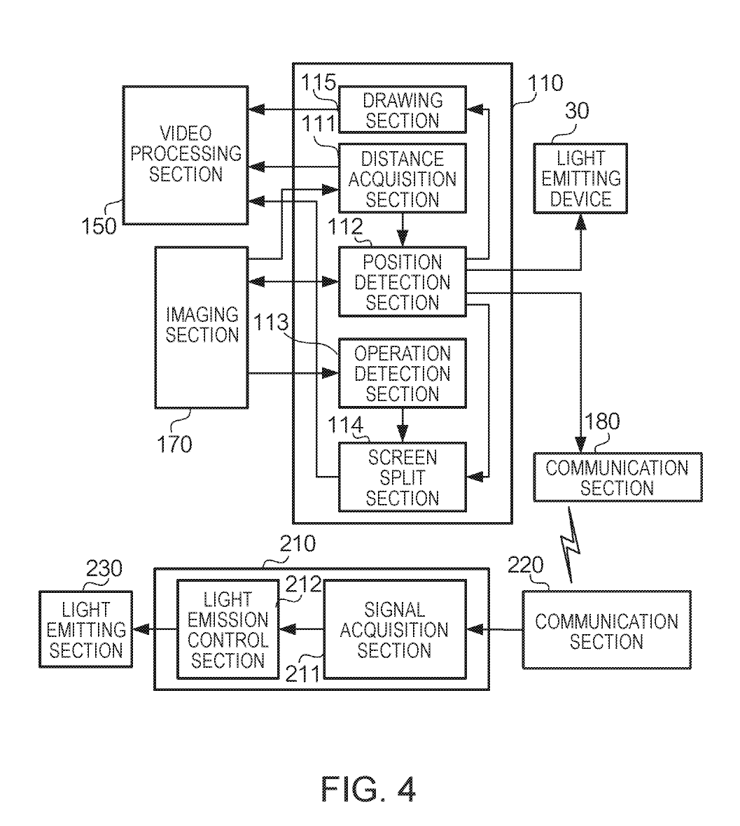

FIG. 4 is a functional block diagram showing a configuration of functions realized by the control section 110 executing programs, and functions realized by the control section 210. Firstly, there will be described the functions realized by the control section 110 of the projector 10.

A distance acquisition section 111 obtains a distance from the imaging section 170 to the projection surface. Specifically, the distance acquisition section 111 controls the image processing section 150 to project a pattern image for measuring the distance from the imaging section 170 to the projection surface on the screen SC. When the pattern image is projected on the screen SC, the distance acquisition section 111 makes the imaging section 170 take the pattern image thus projected to obtain the distance to the projection surface based on the size of the pattern image thus taken. It should be noted that it is also possible for the distance acquisition section 111 to obtain the information related to the distance input by the user operating the remote controller or the operation section 130. Here, the information necessary for the distance acquisition section 111 to obtain is not limited to the distance itself, but can also be information (information corresponding to the distance) related to the distance. In the case in which, for example, the projector 10 does not have a zoom function, since the screen size is determined in accordance with the distance from the imaging section 170 to the projection surface, it is also possible to arrange that the user is required to input the screen size as the information related to the distance. Further, regarding the distance from the imaging section 170 to the projection surface, it is possible to provide a distance sensor to the projector 10, and then obtain the distance from the imaging section 170 to the projection surface from the measurement result of the distance sensor.

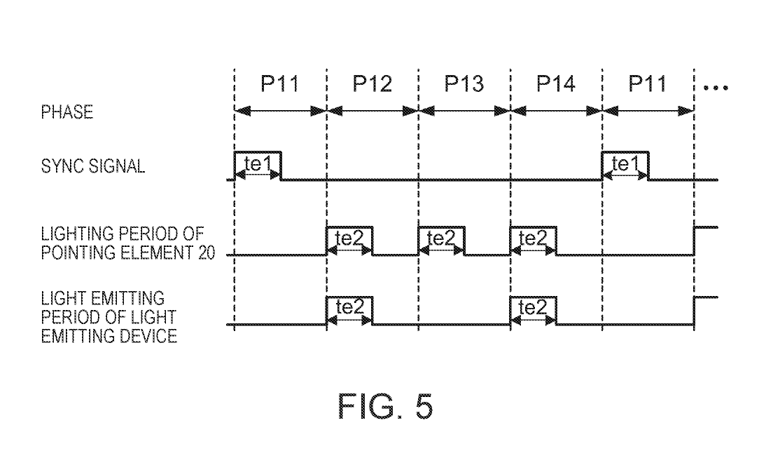

A position detection section 112 identifies a position pointed by the pointer 20 or a finger as an example of the pointer on the screen projected using, for example, the time chart shown in FIG. 5. The period for identifying the position pointed by the finger or the position pointed by the pointer 20 includes four phases, namely from a phase P11 to a phase P14 as shown in FIG. 5. When detecting the position pointed by the finger and the position pointed by the pointer 20, the phases P11 through P14 are repeated. The phase P11 is a phase for synchronizing the timing at which the projector 10 performs imaging with the imaging section 170 and the timing at which the pointer 20 emits light with each other. In the phase P11, the position detection section 112 controls the communication section 180 so that a sync signal of the infrared light is output in a predetermined period te1.

In the pointer 20, the communication section 220 receives the light of the sync signal, and when a predetermined time has elapsed after receiving the sync signal, the control section 210 controls the light emitting section 230 so that the light emitting section 230 lights in the period te2 set in advance. In the present embodiment, the light emitting section 230 is controlled so as to light from a starting point of each of the phases P12, P13, and P14.

Further, the position detection section 112 controls the light emitting device 30 so that the light emitting device 30 emits the infrared light in the period te2 from the starting point of each of the phases P12 and the phases P14.

In the phases P12 through P14, the position detection section 112 controls the imaging section 170 to image the predetermined range including the screen SC at a shutter speed set to the imaging section 170. In the imaging section 170, an exposure period in which the exposure is performed using the electronic shutter function begins at the starting point of each of the phases P12 and P14, and the point at which the exposure ends is determined in accordance with the shutter speed set to the imaging section 170. The image signal of the image taken by the imaging section 170 in the exposure period of each of the phases P12 through P14 is supplied to the position detection section 112.

The position detection section 112 identifies the position pointed by the finger or the pointer 20 on the image thus projected using the image represented by the image signal supplied to the position detection section 112 and the distance obtained by the distance acquisition section 111. Specifically, in the second phase P12 and the fourth phase P14, in the case in which the finger has contact with the screen SC, the infrared light, which has been emitted from the light emitting device 30 and then reflected by the finger, is reflected in the image obtained by the imaging section 170. Further, in the second phase P12 and the fourth phase P14, if the pointer 20 has contact with the screen SC, the infrared light having been emitted from the pointer 20 is also reflected in the image obtained by the imaging section 170. In the third phase P13, since the light emitting device 30 does not emit the light, the infrared light emitted by the pointer 20 is reflected in the image obtained by the imaging section 170.

The position detection section 112 identifies the infrared light located at a position closer to the position of the infrared light reflected in the image obtained by the imaging section 170 in the third phase P13 out of the infrared light reflected in the image obtained by the imaging section 170 in the second phase P12 and the infrared light reflected in the image obtained by the imaging section 170 in the fourth phase P14, and then determines the position of the infrared light thus identified as the position of the pointer 20. Further, the position detection section 112 identifies the infrared light located at a position further from the position of the infrared light reflected in the image obtained by the imaging section 170 in the third phase P13 out of the infrared light reflected in the image obtained by the imaging section 170 in the second phase P12 and the infrared light reflected in the image obtained by the imaging section 170 in the fourth phase P14, and then determines the position of the infrared light thus identified as the position of the finger. The position thus identified is used when using the pointer 20 as a pointing device, or when performing the variety of functions.

An operation detection section 113 analyzes the image signal supplied from the imaging section 170, and then detects a specific operation performed by the user on the projection surface based on the infrared light reflected in the image represented by the image signal.

In the case in which the operation detection section 113 detects the specific operation, a screen split section 114 splits the projection area into a plurality of areas in accordance with the position detected by the position detection section 112, and then controls the image processing section 150 so that images different from each other are respectively displayed in the plurality of areas.

A drawing section 115 performs drawing in accordance with the position detected by the position detection section 112 in the image to be projected. It should be noted that regarding the position where the specific operation detected by the operation detection section 113 has been performed, the drawing section 115 does not perform drawing in accordance with the position detected by the position detection section 112.

Then, there will be described the functions realized by the control section 210 of the pointer 20. The signal acquisition section 211 obtains the sync signal received by the communication section 220. A light emission control section 212 obtains the sync signal from the signal acquisition section 211, and then controls the light emitting section 230 so that the light emitting section 230 lights in the period te2 in each of the phase P12 and the phase P14 when a predetermined time elapses after the sync signal is obtained.

### (Operation Example of Embodiment)

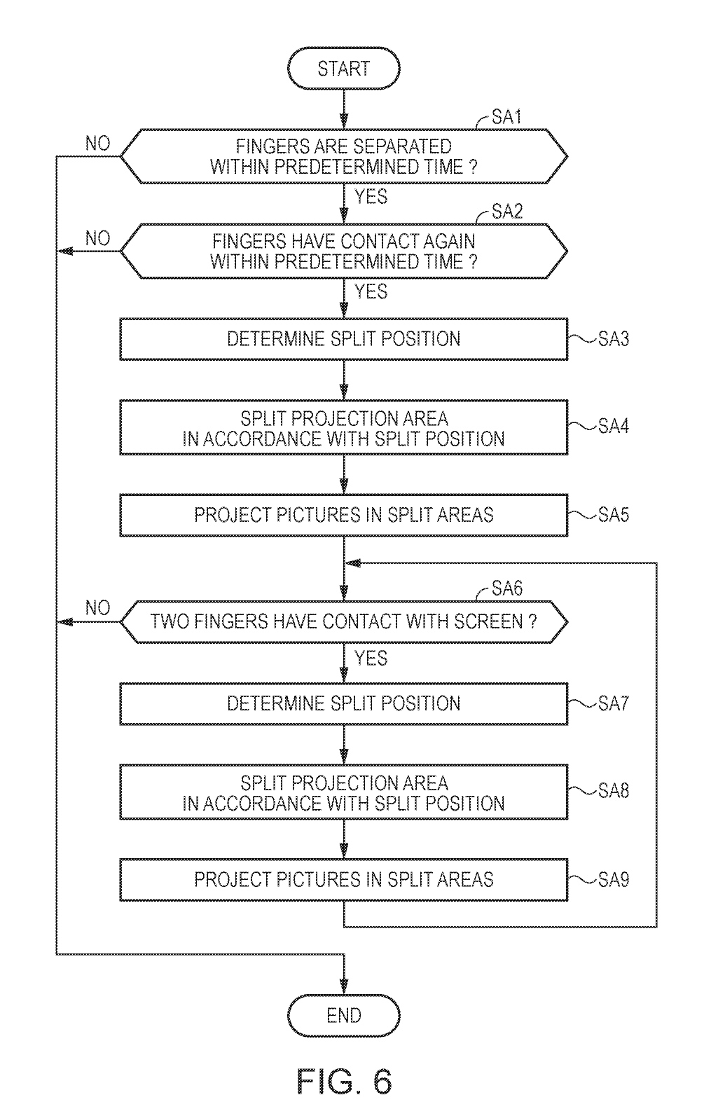

Then, an operation example of the present embodiment will be described with reference to FIGS. 6 through 9. It should be noted that in the following description, the explanation is presented assuming that the image signal supplied to a D-Sub connector of the image interface 160 is a first image source S1, the image signal supplied to an HDMI connector is a second image source S2, an image signal supplied to a USB connector is a third image source S3, and an image signal supplied to an RCA connector is a fourth source connector S4.

(Operation Example when Splitting Projection Screen into Two or More Areas to Project Image of Image Signal Supplied from External Device on Split Areas)

FIG. 6 is a flowchart showing a flow of a process of splitting the projection area into a plurality of areas and projecting the image of the image source supplied from the external device on the split areas. When a predetermined specific operation is performed, the control section 110 performs the process of splitting the projection area. In the present embodiment, the predetermined specific operation (a first operation) is an operation of “touching the projection surface with two fingers→separating the two fingers from the projection surface→making the two fingers have contact with the projection surface again→keeping the two fingers having contact with the projection surface for a period longer than a predetermined time”. The control section 110 analyzes the image signal supplied from the imaging section 170 to determine whether or not the predetermined specific operation has been performed by the user.

Specifically, when the user of the projector 10 firstly touches the projection surface with two fingers (e.g., a thumb and an index finger), the infrared light emitted from the light emitting device 30 is reflected by the two fingers touching the projection surface, and then the light thus reflected enters the imaging section 170. The control section 110 analyzes the image signal supplied from the imaging section 170, and in the case in which two infrared light beams having been reflected by the fingers are reflected in the image taken by the imaging section 170, the control section 110 determines that the two fingers have contact with the screen SC to start the process shown in FIG. 6.

Firstly, the control section 110 determines whether or not the image signal, in which the infrared light beams having been reflected by the fingers are not reflected, is supplied from the imaging section 170 within a predetermined time after it has been determined that the two fingers have contact with the screen SC, namely whether or not the two fingers are separated from the projection surface within a predetermined time after the two fingers have had contact with the projection surface (step SA1). Here, in the case in which the image signal, in which the infrared light beams having been reflected by the fingers are not reflected, is supplied from the imaging section 170 within a predetermined time after it has been determined that the two fingers have contact with the screen SC (YES in the step SA1), the control section 110 determines that the two fingers are separated from the projection surface within the predetermined time.

Then, the control section 110 determines whether or not the image signal, in which the two infrared light beams reflected by the fingers are reflected, has been supplied from the imaging section 170 within a predetermined time after it has been determined YES in the step SA1, namely whether or not the two fingers have had contact with the projection surface again within the predetermined time (step SA2). Here, in the case in which the two infrared beams reflected by the fingers are reflected in the image taken within the predetermined time after it has been determined YES in the step SA1 (YES in the step SA2), the control section 110 determines that the two fingers have had contact within the predetermined time.

In the case in which it has been determined YES in the step SA2, the control section 110 identifies the positions of the two fingers on the projection surface, and then determines the split position when splitting the projection area into two or more areas based on the position thus identified (step SA3). Here, the control section 110 identifies the position of the midpoint of a line segment connecting the positions of the two fingers, and then uses the position thus identified as a split position Pos.

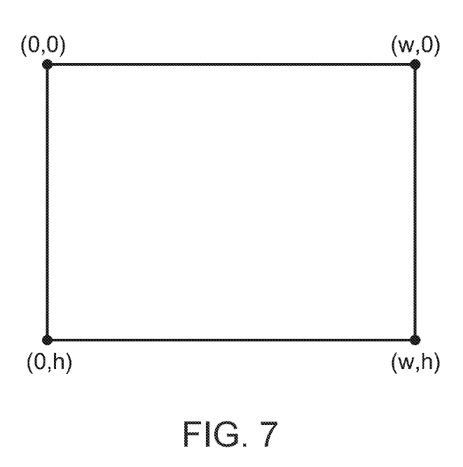

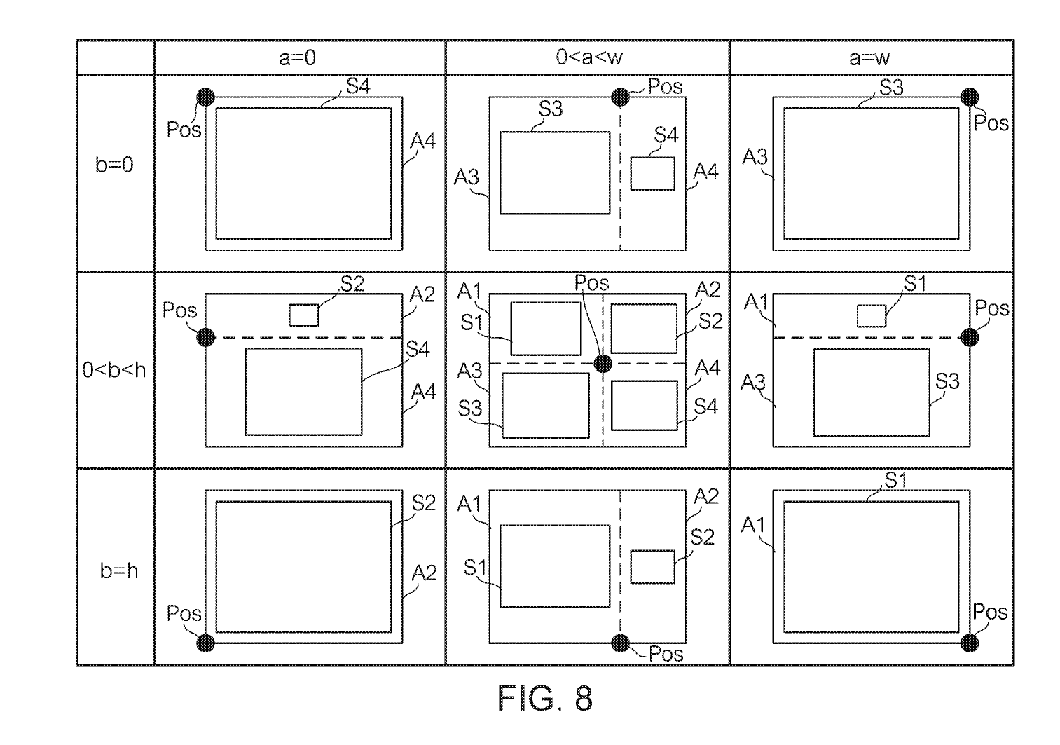

In the present embodiment, as shown in FIG. 7, assuming that the width of the projection area having a rectangular shape in the non-split state is w, and the height thereof is h, and the coordinate of the upper left vertex of the projection area is (0, 0), the coordinate of the upper right vertex becomes (w, 0), the coordinate of the lower left vertex becomes (0, h), and the coordinate of the lower right vertex becomes (w, h). The control section 110 splits the projection area as, for example, shown in FIG. 8 in accordance with the coordinate of the split position Pos thus identified (step SA4).

In the present embodiment, in the case in which the coordinate of the split position Pos is assumed as (a, b), if, for example, the coordinate in the horizontal direction of the split position Pos fulfills 0<a<w, and the coordinate in the vertical direction of the split position Pos fulfills 0<b<h, the control section 110 splits the projection area into four areas as shown in the second row and the second column of FIG. 8. Further, if the coordinate in the horizontal direction of the split position Pos fulfills 0<a<w, and the coordinate in the vertical direction of the split position Pos fulfills b=0 or b=h, the control section 110 splits the projection area into two areas as shown in the first row and the second column, or the third row and the second column of FIG. 8. Further, if the coordinate in the vertical direction of the split position Pos fulfills 0<b<h, and the coordinate in the horizontal direction of the split position Pos fulfills a=0 or a=w, the control section 110 splits the projection area into two areas as shown in the second row and the first column, or the second row and the third column of FIG. 8.

Then, the control section 110 controls the image processing section 150 so that the images of the image sources corresponding to the respective areas are projected in the respective areas obtained by the split in accordance with the information stored in the first table (step SA5). For example, the control section 110 splits the projection area into four areas, and uses the upper left area as a first area A1, the upper right area as a second area A2, the lower left area as a third area A3, and the lower light area as a fourth area A4 as shown in the second row and the second column of FIG. 8. Then, in the case in which the first table is in the state shown in FIG. 3, the control section 110 controls the image processing section 150 in accordance with the first table so that the image of the first image source S1 is projected in the first area A1, the image of the second image source S2 is projected in the second area A2, the image of the third image source S3 is projected in the third area A3, and the image of the fourth image source S4 is projected in the fourth area A4.

The control section 110 splits the projection area, and then determines whether or not the two infrared light beams reflected by the fingers are reflected in the image taken by the imaging section 170, namely whether or not the two fingers have contact with the screen SC (step SA6). In the case in which the infrared light beams reflected by the fingers are not reflected in the image thus taken, namely the fingers of the user are separated from the projection surface after splitting the projection area, the control section 110 terminates the process shown in FIG. 6.

Further, in the case in which the infrared light beams reflected by the two fingers are reflected in the image thus taken (YES in the step SA6), the control section 110 determines that the two fingers have contact with the screen SC. In the case in which it has been determined YES in the step SA6, the control section 110 identifies the positions of the two fingers on the projection surface, and then determines the latest split position Pos when splitting the projection area into two or more areas based on the position thus identified (step SA7). Here, in the case in which the two fingers have moved and the newly identified split position Pos is different from the position having been identified last time, the control section 110 splits the projection area in accordance with the split position Pos newly identified (step SA8). Then, the control section 110 controls the image processing section 150 so that the images are projected in the respective areas obtained by the split in accordance with the information stored in the first table (step SA9), and then returns the flow of the process to the step SA6.

For example, in the case in which the coordinate in the horizontal direction of the split position Pos fulfills 0<a<w, and the coordinate in the vertical direction of the split position fulfills b=0, the control section 110 splits the projection area into two areas in the horizontal direction, uses the left area as the third area A3, and the right area as the fourth area A4, and controls the image processing section 150 so that the image of the third image source S3 is projected in the third area A3, and the image of the fourth image source S4 is projected in the fourth area A4 as shown in the first row and the second column of FIG. 8.

Further, in the case in which the coordinate in the horizontal direction of the split position Pos fulfills 0<a<w, and the coordinate in the vertical direction of the split position Pos fulfills b=h, the control section 110 splits the projection area into two areas in the horizontal direction, uses the left area as the first area A1, and the right area as the second area A2, and controls the image processing section 150 so that the image of the first image source S1 is projected in the first area A1, and the image of the second image source S2 is projected in the second area A2 as shown in the third row and the second column of FIG. 8.

Further, in the case in which the coordinate in the horizontal direction of the split position Pos fulfills a=0, and the coordinate in the vertical direction of the split position Pos fulfills 0<b<h, the control section 110 splits the projection area into two areas in the vertical direction, uses the upper area as the second area A2, and the lower area as the fourth area A4, and controls the image processing section 150 so that the image of the second image source S2 is projected in the second area A2, and the image of the fourth image source S4 is projected in the fourth area A4 as shown in the second row and the first column of FIG. 8.

Further, in the case in which the coordinate in the horizontal direction of the split position Pos fulfills a=w, and the coordinate in the vertical direction of the split position Pos fulfills 0<b<h, the control section 110 splits the projection area into two areas in the vertical direction, uses the upper area as the first area A1, and the lower area as the third area A3, and controls the image processing section 150 so that the image of the first image source S1 is projected in the first area A1, and the image of the third image source S3 is projected in the third area A3 as shown in the second row and the third column of FIG. 8.

Further, in the case in which the coordinate of the split position Pos coincides with the coordinate of one of the vertexes of the projection area, the control section 110 selects the image to be projected in accordance with the first table and the coordinate of the split position Pos, and then projects the image thus selected. For example, in the case in which the coordinate in the horizontal direction of the split position Pos fulfills a=0, and the coordinate in the vertical direction fulfills b=0, the control section 110 uses the projection area as the fourth area A4, and controls the image processing section 150 so that the image of the fourth image source S4 is projected in the projection area as shown in the first row and the first column of FIG. 8. Further, in the case in which the coordinate in the horizontal direction of the split position Pos fulfills a=w, and the coordinate in the vertical direction fulfills b=0, the control section 110 uses the projection area as the third area A3, and controls the image processing section 150 so that the image of the third image source S3 is projected in the projection area as shown in the first row and the third column of FIG. 8. Further, in the case in which the coordinate in the horizontal direction of the split position Pos fulfills a=0, and the coordinate in the vertical direction fulfills b=h, the control section 110 uses the projection area as the second area A2, and controls the image processing section 150 so that the image of the second image source S2 is projected in the projection area as shown in the third row and the first column of FIG. 8. Further, in the case in which the coordinate in the horizontal direction of the split position Pos fulfills a=w, and the coordinate in the vertical direction fulfills b=h, the control section 110 uses the projection area as the first area A1, and controls the image processing section 150 so that the image of the first image source S1 is projected in the projection area as shown in the third row and the third column of FIG. 8.

As described hereinabove, according to the present embodiment, it is possible to split the projection area into a plurality of areas, and then project the plurality of images without operating the operation section 130 or the remote controller.

(Operation Example when in the Case of Exchanging Images Projected in Split Areas)

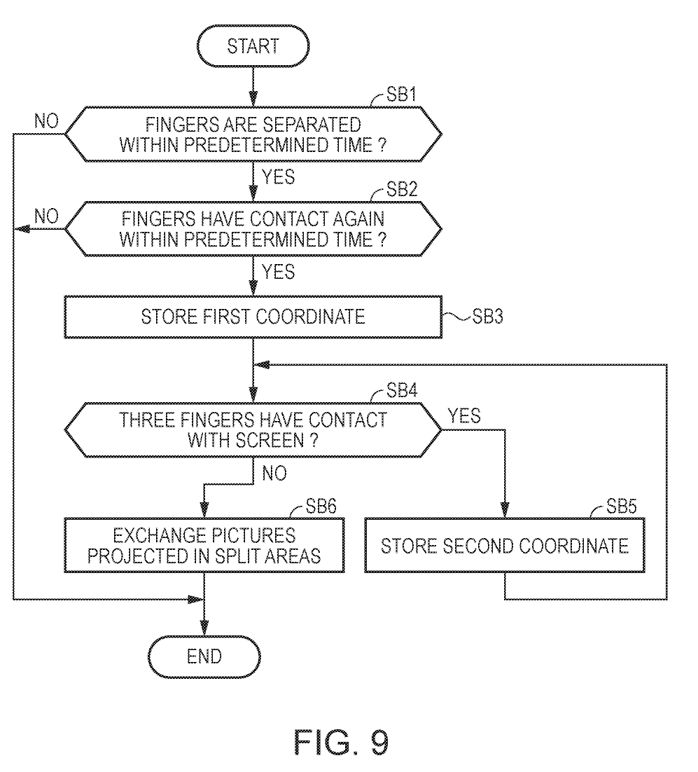

FIG. 9 is a flowchart showing a flow of the process of exchanging the images projected in the split areas. When a predetermined specific operation is performed in the state in which the projection area is split, the control section 110 performs the process of exchanging the images projected in the two areas for each other. In the present embodiment, the predetermined specific operation (a third operation) triggering the process of exchanging the images projected in the split areas is an operation of “touching the projection surface with three fingers→separating the three fingers from the projection surface→making the three fingers have contact with the projection surface again→keeping the three fingers having contact with the projection surface for a period longer than a predetermined time”. The control section 110 analyzes the image signal supplied from the imaging section 170 to determine whether or not the predetermined specific operation has been performed with the fingers of the user.

Specifically, when the user of the projector 10 firstly touches the projection surface with three fingers (e.g., a thumb, an index finger, and a middle finger), the infrared light emitted from the light emitting device 30 is reflected by the three fingers touching the projection surface, and then the light thus reflected enters the imaging section 170. The control section 110 analyzes the image signal supplied from the imaging section 170, and in the case in which three infrared light beams having been reflected by the fingers are reflected in the image taken by the imaging section 170, the control section 110 determines that the three fingers have contact with the screen SC to start the process shown in FIG. 9.

Firstly, the control section 110 determines whether or not the image signal, in which the infrared light beams having been reflected by the fingers are not reflected, is supplied from the imaging section 170 within a predetermined time after it has been determined that the three fingers have contact with the screen SC in the image taken, namely whether or not the three fingers are separated from the projection surface within a predetermined time after the three fingers have had contact with the projection surface (step SB1). Here, in the case in which the image signal, in which the infrared light beams having been reflected by the fingers are not reflected, is supplied from the imaging section 170 within a predetermined time after it has been determined that the three fingers have contact with the screen SC (YES in the step SB1), the control section 110 determines that the three fingers are separated from the projection surface within the predetermined time.

Then, the control section 110 determines whether or not the image signal, in which the three infrared light beams reflected by the fingers are reflected, has been supplied from the imaging section 170 within a predetermined time after it has been determined YES in the step SB1, namely whether or not the three fingers have had contact with the projection surface again within the predetermined time (step SB2). Here, in the case in which the three infrared beams reflected by the fingers are reflected in the image taken within the predetermined time after it has been determined YES in the step SB1 (YES in the step SB2), the control section 110 determines that the three fingers have had contact within the predetermined time.

In the case in which it has been determined YES in the step SB2, the control section 110 identifies the positions of the three fingers on the projection surface, and then stores one of the coordinates of the three positions thus identified in the RAM as a first coordinate (step SB3). It should be noted that although in the present embodiment, the coordinate of the position of the finger located at the uppermost position out of the positions of the three fingers is used as the first coordinate, it is also possible to use the coordinate of the position of the finger located at the lowermost position as the first coordinate. Further, the position of the finger closest to the origin in the horizontal direction out of the positions of the three fingers can also be used as the first coordinate, or the position of the finger furthest to the origin in the horizontal direction out of the positions of the three fingers can also be used as the first coordinate.

The control section 110 stores the first coordinate, and then analyzes the image signal supplied from the imaging section 170 to determine whether or not the three fingers have contact with the projection surface (step SB4). In the case in which the infrared light beams are reflected in three places in the image represented by the image signal supplied from the imaging section 170, namely in the case in which the fingers of the user are not separated from the projection surface, the control section 110 identifies the positions of the three fingers, and then stores one of the coordinates of the three positions thus identified in the RAM as a second coordinate (step SB5). Then, the control section 110 returns the flow of the process to the step SB4, and then identifies the position of the finger located at the uppermost position out of the three fingers to update the second coordinate with the coordinate of the position thus identified during the period in which the three fingers of the user have contact.

In the case in which the infrared light beams are not reflected in the image represented by the image signal supplied from the imaging section 170, namely in the case in which the three fingers of the user are separated from the projection surface (NO in the step SB4), the control section 110 exchanges the images projected on the split areas based on the first coordinate and the second coordinate stored in the RAM (step SB6).

Specifically, the control section 110 identifies a first exchange area including the first coordinate stored and a second exchange area including the second coordinate stored.

For example, assuming that the coordinate of the split position in the case in which the projection area is split into four areas is (a, b), and the first coordinate is (c, d), the control section 110 identifies the first area A1 as the first exchange area in the case in which c<a and d<b are fulfilled, identifies the second area A2 as the first exchange area in the case in which ca and d<b are fulfilled, identifies the third area A3 as the first exchange area in the case in which c<a and c≧a are fulfilled, and identifies the fourth area A4 as the first exchange area in the case in which c≧a and d≧b are fulfilled.

Further, assuming that the coordinate of the split position in the case in which the projection area is split into four areas is (a, b), and the second coordinate is (e, f), the control section 110 identifies the first area A1 as the second exchange area in the case in which e<a and f<b are fulfilled, identifies the second area A2 as the second exchange area in the case in which ea and f<b are fulfilled, identifies the third area A3 as the second exchange area in the case in which e<a and f≧b are fulfilled, and identifies the fourth area A4 as the second exchange area in the case in which e≧a and f≧b are fulfilled.

Further, assuming that the coordinate of the split position in the case in which the projection area is split into two areas is (a, b), and the first coordinate is (c, d), if 0<a<w and b=0 are fulfilled, the control section 110 identifies the third area A3 as the first exchange area in the case of c<a, and identifies the fourth area A4 as the first exchange area in the case of c≧a. Further, assuming that the coordinate of the split position in the case in which the projection area is split into two areas is (a, b), and the second coordinate is (e, f), if 0<e<w and b=0 are fulfilled, the control section 110 identifies the third area A3 as the second exchange area in the case of e<a, and identifies the fourth area A4 as the second exchange area in the case of e≧a.

Further, assuming that the coordinate of the split position in the case in which the projection area is split into two areas is (a, b), and the first coordinate is (c, d), if 0<a<w and b=h are fulfilled, the control section 110 identifies the first area A1 as the first exchange area in the case of c<a, and identifies the second area A2 as the first exchange area in the case of c≧a. Further, assuming that the coordinate of the split position in the case in which the projection area is split into two areas is (a, b), and the second coordinate is (e, f), if 0<e<w and b=h are fulfilled, the control section 110 identifies the first area A1 as the second exchange area in the case of e<a, and identifies the second area A2 as the second exchange area in the case of e≧a.

Further, assuming that the coordinate of the split position in the case in which the projection area is split into two areas is (a, b), and the first coordinate is (c, d), if 0<b<h and a=0 are fulfilled, the control section 110 identifies the second area A2 as the first exchange area in the case of d<b, and identifies the fourth area A4 as the first exchange area in the case of d≧b. Further, assuming that the coordinate of the split position in the case in which the projection area is split into two areas is (a, b), and the second coordinate is (e, f), if 0<f<h and a=0 are fulfilled, the control section 110 identifies the second area A2 as the second exchange area in the case of f<b, and identifies the fourth area A4 as the second exchange area in the case of f≧b.

Further, assuming that the coordinate of the split position in the case in which the projection area is split into two areas is (a, b), and the first coordinate is (c, d), if 0<b<h and a=w are fulfilled, the control section 110 identifies the first area A1 as the first exchange area in the case of d<b, and identifies the third area A3 as the first exchange area in the case of d≧b. Further, assuming that the coordinate of the split position in the case in which the projection area is split into two areas is (a, b), and the second coordinate is (e, f), if 0<f<h and a=w are fulfilled, the control section 110 identifies the first area A1 as the second exchange area in the case of f<b, and identifies the third area A3 as the second exchange area in the case of f≧b.

In the case in which the first exchange area and the second exchange area are the same, the control section 110 does not exchange the images projected in the split areas for each other but terminates the process shown in FIG. 9. In the case in which the first exchange area and the second exchange area are different from each other, the control section 110 exchanges the image source of the image projected in the first exchange area and the image source of the image projected in the second exchange area for each other.

For example, in the case in which the projection area is split into four areas, the first exchange area is the first area A1, and the second exchange area is the fourth area A4, the control section 110 exchanges the image source associated with the first area in the first table and the image source associated with the fourth area in the first table for each other. Thus, in the first table, the fourth image source S4 is associated with the first area, and the first image source S1 is associated with the fourth area. The control section 110 controls the image processing section 150 in accordance with the information stored in the first table thus updated so that the fourth image source S4 is projected in the first area A1 located in the upper left part, the second image source S2 is projected in the second area located in the upper right part, the third image source S3 is projected in the third area located in the lower left part, and the first image source S1 is projected in the fourth area A4 located in the lower right part.

As described hereinabove, according to the present embodiment, it is possible to exchange the images projected in the plurality of projection areas for each other without operating the operation section 130 or the remote controller.

### Modified Examples

Although the embodiment of the invention is described hereinabove, the invention is not limited to the embodiment described above, but can be implemented in other various forms. For example, the invention can be implemented by modifying the embodiment described above as follows. It should be noted that the embodiment described above and the following modified examples can be implemented alone or in arbitrary combination.

In the embodiment described above, it is also possible to detect the presence or absence of the image sources supplied to the connectors of the image interface 160 to determine the number of the split areas in accordance with the presence or absence of the image sources supplied to the connectors of the image interface 160.

For example, in the case in which the image sources are supplied to two of the four connectors, and the rest two of the four connectors are not supplied with the image source, even if the coordinate in the horizontal direction of the split position Pos fulfills 0<a<w, and the coordinate in the vertical direction of the split position Pos fulfills 0<b<h, it is also possible to arrange that the projection area is split vertically or horizontally into two areas, and to project the images of the image sources, which are supplied to the connectors, in the split areas.

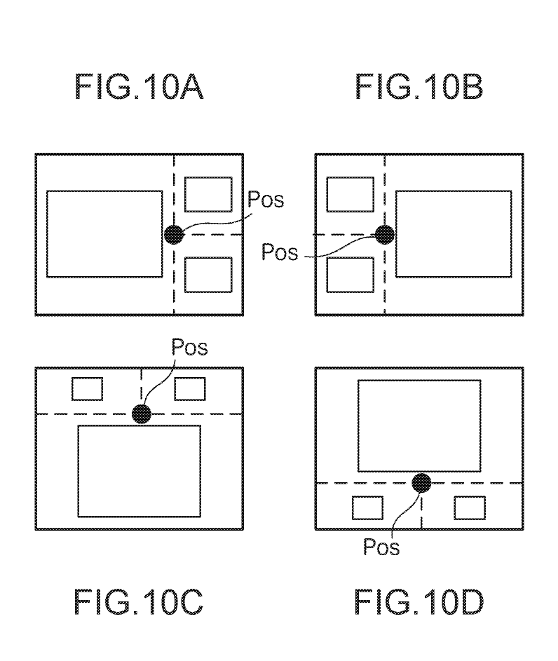

Further, in the case in which the image sources are supplied to three of the four connectors, and the rest one of the four connectors are not supplied with the image source, if the coordinate in the horizontal direction of the split position Pos fulfills 0<a<w, and the coordinate in the vertical direction of the split position Pos fulfills 0<b<h, it is also possible to arrange that the projection area is split into three areas, and to project the images of the image sources, which are supplied to the connectors, in the split areas. In the case of splitting the projection area into three areas, it is also possible to arrange that, for example, the split is performed in either of the states shown in FIGS. 10(a) through 10(d).

In the embodiment described above, it is also possible to arrange that in the state in which the projection area is split, and the fingers are separated from the projection surface, when an operation (a second operation) of “touching the projection surface with two fingers→separating the two fingers from the projection surface→making the two fingers have contact with the projection surface again” is performed, the control section 110 makes the transition of the flow of the process to the step SA6 of the flowchart shown in FIG. 6. According to this configuration, in the case in which the operation of “touching the projection surface with two fingers→separating the two fingers from the projection surface→making the two fingers have contact with the projection surface again” is performed in the state in which the projection surface is split, and then the two fingers are moved while having contact with the projection surface, the split position Pos is changed.

In the embodiment described above, the first operation, the second operation, and the third operation can also be operations other than the operations illustrated in the embodiment.

Although in the embodiment described above, the operation triggering the split of the projection area is assumed to be the operation with the fingers, the operation triggering the split of the projection area is not limited to the operation with fingers, but can also be an operation with, for example, the pointer 20.

For example, it is also possible to arrange that when the operation of “touching the projection surface with the pointer 20→separating the pointer 20 from the projection surface→making the pointer 20 have contact with the projection surface again→keeping the pointer 20 having contact with the projection surface for a period longer than a predetermined time” is performed in the state in which the function of performing drawing on the screen in accordance with the position of the pointer 20 is not performed, the control section 110 splits the projection area based on the position where the pointer 20 has contact.

Further, it is also possible to arrange that if the pointer 20 is moved in a spiral manner while keeping the pointer 20 having contact with the projection surface in the state in which the function of performing drawing on the screen in accordance with the position of the pointer 20 is not performed, the projection area is split based on the position where the pointer 20 has contact, or it is also possible to arrange that when the pointer 20 is moved on the projection surface so as to draw a specific character or symbol besides the spiral shape, the projection area is split based on the position where the pointer 20 has contact.

Further, it is also possible to provide a button to the pointer 20, transmit a signal representing the fact that the button is held down from the pointer 20 to the projector 10 with wireless communication when the button is held down, and it is possible for the projector 10 to detect the position of the pointer 20 on the projection image when the projector 10 receives the signal, and then split the projection area based on the position thus detected.

Further, the operation triggering the execution of the process of exchanging the images projected in the split areas is not limited to the operation with the fingers, but can also be an operation with the pointer 20.

Although in the embodiment described above, the device for displaying the image is assumed to be the projector 10 for projecting an image, a direct-view display device such as a liquid crystal television or a liquid crystal monitor can also be adopted.

### REFERENCE SIGNS LIST

1 . . . display system
10 . . . projector
20 . . . pointer
30 . . . light emitting device
110 . . . control section
111 . . . distance acquisition section
112 . . . position detection section
113 . . . operation detection section
114 . . . screen split section
115 . . . drawing section
120 . . . storage section
130 . . . operation section
140 . . . projection section
150 . . . image processing section
160 . . . image interface
170 . . . imaging section
180 . . . communication section
210 . . . control section
211 . . . signal acquisition section
212 . . . light emission control section
220 . . . communication section
230 . . . light emitting section
240 . . . operation section
250 . . . power supply
SC . . . screen
Pos . . . split position
S1 . . . first image source
S2 . . . second image source
S3 . . . third image source
S4 . . . fourth image source

1. A display device comprising:
an image acquisition section adapted to obtain a plurality of image signals;
a display section adapted to display images represented by the image signals obtained by the image acquisition section;
a position detection section adapted to detect a position pointed by a pointer on a screen displayed by the display section;
an operation detection section adapted to detect an operation performed by the pointer on the screen; and
a screen split section adapted to split the screen displayed by the display section into a plurality of areas in accordance with the position detected by the position detection section in a case in which a first operation is detected by the operation detection section, and allocate the images represented by the image signals obtained by the image acquisition section to the respective areas so that the images different from each other are displayed in the plurality of areas,
wherein, when assuming that the width of the screen is w, the height of the screen is h, the coordinate of the upper left vertex of the screen is (0, 0), the coordinate of the upper right vertex of the screen is (w, 0), the coordinate of the lower left vertex of the screen is (0, h), the coordinate of the lower right vertex of the screen is (w, h), and the coordinate of the position detected by the position detection section is (a, b), the screen split section splits the screen into four areas if 0<a<w and 0<b<h are fulfilled.

2. The display device according to claim 1, wherein
in a case in which the operation detection section detects a second operation in a state in which the screen is split, and then the position detected by the position detection section changes, the screen split section changes sizes of the plurality of areas in accordance with the position having been changed.

3. The display device according to claim 2, wherein
at least one of the first operation and the second operation is an operation of making the pointer have contact with the screen a plurality of times.

4. The display device according to claim 1, wherein
the screen split section determines the number of the plurality of areas in accordance with the position detected by the position detection section.

5. The display device according to claim 1, wherein
the screen split section determines the number of the plurality of areas in accordance with the number of the image signals obtained by the image acquisition section.

6. The display device according to claim 1, wherein
in a case in which the operation detection section detects a third operation in a state in which the screen is split, the screen split section exchanges the image displayed in a first position pointed by the pointer and the image displayed in a second position pointed by the pointer for each other.

7. The display device according to claim 1, further comprising a drawing section adapted to perform drawing in the screen in accordance with the position detected by the position detection section,
wherein the drawing section skips drawing in accordance with the position of the pointer with respect to an operation detected by the operation detection section.

8. A display control method comprising:
a position detection step of detecting a position pointed by a pointer on a screen displayed by a display section;
an operation detection step of detecting an operation performed by the pointer on the screen; and
a screen split step of splitting the screen displayed by the display section into a plurality of areas in accordance with the position detected in the position detecting step in a case in which a first operation is detected in the operation detection step, and allocating images represented by a plurality of image signals obtained by an image acquisition section to the respective areas so that the images different from each other are displayed in the plurality of areas,
wherein, when assuming that the width of the screen is w, the height of the screen is h, the coordinate of the upper left vertex of the screen is (0, 0), the coordinate of the upper right vertex of the screen is (w, 0), the coordinate of the lower left vertex of the screen is (0, h), the coordinate of the lower right vertex of the screen is (w, h), and the coordinate of the position detected by the position detection step is (a, b), in the screen split step, the screen is split into four areas if 0<a<w and 0<b<h are fulfilled.
